(19) United States
(12) Patent Application Publication
(10) Pub. No.: US 2026/0131414 A1
(43) Pub. Date: May 14, 2026

(54) METHOD AND SYSTEM FOR MONITORING WEAR STATE OF MILLING TOOLS FOR COMPLEX THIN-WALLED COMPONENTS

(71) Applicant: SHANDONG UNIVERSITY, Jinan (CN)

(72) Inventors: Qinghua SONG, Jinan (CN); Xiaojuan WANG, Jinan (CN); Yicong DU, Jinan (CN); Haifeng MA, Jinan (CN); Zhanqiang LIU, Jinan (CN)

(21) Appl. No.: 18/940,975

(22) Filed: Nov. 8, 2024

(51) Int. Cl. B23Q 17/09

(52) U.S. Cl. CPC B23Q 17/0957; B23Q 17/0995

(57) ABSTRACT

The present invention provides a method and system for monitoring wear state of milling tools for complex thin-walled components, comprising: taking monotonicity of feature vector as a first index, normalized mutual information of the feature vector and wear vector of the tool as a second index, and a ReLU function of Spearman correlation coefficients between feature vectors and the wear vector of the tool as a third index; according to the above indexes, determining behavior indexes corresponding to each feature vector; characterizing behavior characterizations of signal channels, comparing channel behavior indexes of each signal channel, determining input vectors of model, and training tool state recognition model according to the input vectors; and tool change is determined and performed timely by comparing output wear amount value of the tool by using the model with a threshold value.

### TECHNICAL FIELD

The present invention relates to the technical field of thin-walled component cutting process monitoring, in particular to a method and system for monitoring wear state of milling tools for complex thin-walled components.

### BACKGROUND OF THE INVENTION

Due to its advantages in structure, specific stiffness and specific strength, thin-walled workpieces of difficult-to-machine materials such as titanium alloy and superalloy are widely used in key components of aeroengine such as impellers, blades, integral bladed disks and casings. However, these workpieces have low thermal conductivity, large cutting force and rapid tool wear in cutting process. With the development of artificial intelligence technology, cutting data-driven tool condition on-line monitoring technology provides the possibility to solve this problem.

Under reasonable process parameters, the cutting process of general workpiece can be kept relatively stable. With the tool dulling, the signal features and tool wear are obviously nonlinear correlation. Multi-domain features related to tool state evolution are extracted from sensor signals, and real-time monitoring of tool wear can be realized by combining pattern recognition methods such as machine learning and deep learning. For example, the Chinese Patent CN114905336A discloses a method and system for monitoring tool wear under variable working conditions based on decoupling of cutting force components, which monitors the state of the tool by calculating cutting force increments and theoretical cutting forces caused by tool wear, thereby realizing tool wear failure identification under variable load conditions. The Chinese Patent CN106514434B discloses a data-based milling tool wear monitoring method, which extracts feature coefficients capable of characterizing milling tool wear from three-phase output current signals of a spindle drive motor, so that milling tool wear can be monitored in real-time during machining.

However, forced vibration and self-excited vibration caused by the weak rigidity of thin wall system are difficult to avoid in the milling of thin-walled components such as aeroengine impeller and blade. Due to the influence of random tool-workpiece vibration, the behavior evolution mechanism of signal features is obviously different from that of conventional cutting of the workpiece, and the correlation between multi-domain features and wear is greatly reduced, which makes it difficult to reliably identify tool wear in thin-walled workpiece milling process. At the same time, the non-normal distribution of feature vectors of thin-walled workpiece cutting data makes it difficult to quantitatively characterize its feature evolution mode, which makes the existing tool condition monitoring of thin-walled workpiece rarely consider the behavior law of multi-domain features. The tool wear recognition accuracy can only be improved by original methods such as model expansion and feature space complexity. The complexity of the model and feature space leads to the consumption of a large number of computational resources in the training process, and the complex recognition model is difficult to be extended to different working conditions, resulting in the condition monitoring algorithm cannot adapt to the actual engineering.

### SUMMARY OF THE INVENTION

Aiming at the defects existing in the prior arts, one object of the present invention is to provide a method and system for monitoring wear state of milling tools for complex thin-walled components, which can accurately determine an input signal channel and a signal feature vector of a tool state recognition model through quantitative characterization of a cutting signal multi-domain feature behavior evolution rule and a channel behavior evolution rule, solves the problem that the wear monitoring accuracy of the tool is difficult to guarantee due to random influence of tool-workpiece vibration in milling of thin-walled components, to achieve timely replacement of the tools.

In order to achieve the above object, the present invention is realized through the following technical solution.

In a first aspect, one or more embodiments of the present invention provide a method for monitoring wear state of milling tools for complex thin-walled components, comprising:
collecting cutting signals in all cutting signal channels of a tool of a machining center by tool cutting signal collection equipment mounted on the machining center and transmitting to a processor;
extracting, by the processor, feature vectors of each of the cutting signal channels and constructing a signal feature matrix for the each of the cutting signal channels;
calculating, by the processor, a monotonicity of each of the feature vectors in the each of the cutting signal channels as a first index, calculating normalized mutual information of the each of the feature vectors in the each of the cutting signal channels and a tool wear vector as a second index, and calculating Spearman correlation coefficients between the each of the feature vectors in the each of the cutting signal channels and the tool wear vector, then calculating a third index based on a preset relationship between the Spearman correlation coefficients and the third index; wherein, the tool wear vector is constructed by the processor from historical tool wear amounts of the tool of the machining center measured by an electron microscope;
obtaining, by the processor, feature behavior indexes corresponding to the each of the feature vectors in the each of the cutting signal channels according to a preset relationship between an accumulation sum of the first index, the second index and the third index and the feature behavior indexes;
calculating, by the processor, a cumulative average of the feature behavior indexes corresponding to the each of the feature vectors in the each of the cutting signal channels as a channel behavior index of a corresponding cutting signal channel;
sorting, by the processor, the each of the cutting signal channels according to a size of the channel behavior index, screening the cutting signal channels with a set number of top rankings as input signal channels, and selecting a feature vector with a largest feature behavior index in time domain, frequency domain and time frequency domain of each of the input signal channels, respectively, to form model input vectors;
outputting, by the processor, an online monitoring value of a wear amount of the tool of the machining center based on the model input vectors and the tool state recognition model trained in advance; and
replacing the tool of the machining center when the online monitored value of the wear amount of the tool is greater than a predefined wear amount threshold.

As a further implementation, the processor calculates the monotonicity of the each of the feature vectors in the each of the cutting signal channels, expressing as:

$$M {O}_{i j} = \vert corr ( rank ( {f}_{i j} ) , rank ( {t}_{i j} ) ) \vert$$

where, MOᵢⱼ denotes monotonicity of feature vector; corr denotes calculated Spearman rank correlation coefficient, rank denotes calculated Spearman rank, and tᵢⱼ denotes time series vector corresponding to feature vector fᵢⱼ.

As a further implementation, the processor calculates the normalized mutual information of the each of the feature vectors in the each of the cutting signal channels and the tool wear vector, expressing as:

$${NI}_{i j} = \frac{{I}_{i j} ( {f}_{i j} ; {w}_{j} )}{H ( {f}_{i j} ) + H ( {w}_{j} )}$$

where, NIᵢⱼ denotes normalized mutual information between feature vector fᵢⱼ and tool wear vector wⱼ; Iᵢⱼ(fᵢⱼ; wⱼ) denotes mutual information between computed feature vector fᵢⱼ and tool wear vector wⱼ of the j^{th} tool; H(⋅) denotes computed vector information entropy.

As a further implementation, the processor calculates the third index, expressing as:

$${C}_{i j} = R e L U ( {r}_{i j} )$$

$${r}_{i j} = 1 - \frac{6 {{\sum }_{u = 1}^{m} [ {d}_{ij}^{( u )} ]}^{2}}{m ( {m}^{2} - 1 )}$$

$$ReLU ( x ) = max ( 0 , x )$$

where, rᵢⱼ is the Spearman correlation coefficient between feature vector fᵢⱼ and tool wear vector wⱼ; ReLU(x) is the expression of ReLU function;

$${d}_{i j}^{( u )}$$

denotes the rank difference between the u^{th} feature data in feature vector fᵢⱼ and the u^{th} tool wear value in tool wear vector wⱼ.

As a further implementation, the preset relationship between the accumulation sum of the first index, the second index and the third index and the feature behavior index, expressing as:

$${P}_{i j} = σ ( M {O}_{i j} + {NI}_{i j} + {C}_{i j} )$$

where, Pᵢⱼ denotes the feature behavior index corresponding to the feature vector fᵢⱼ; MOᵢⱼ, NIᵢⱼ, and Cᵢⱼ denote the first index, the second index, and the third index corresponding to the feature vector fᵢⱼ, respectively; σ(⋅) denotes the Sigmoid activation function.

As a further implementation, the cutting signal channels of the tool comprises a combination of at least any two signal channels of a milling force signal channel, a workpiece acceleration signal channel, a cutting noise signal channel and an acoustic emission signal channel.

As a further implementation, milling force signals in the milling force signal channel are collected by using a rotary force measuring tool holder.

As a further implementation, a three-axis accelerometer is used to collect workpiece acceleration signals in the workpiece acceleration signal channel.

As a further implementation, the tool state recognition model is a lightweight gate recurrent unit (GRU) network with four layers, wherein a first layer and a second layer comprise a plurality of bidirectional GRUs, and a third layer and a fourth layer comprise a plurality of fully connected layers of neurons.

In a second aspect, one or more embodiments of the present invention further provide a system for monitoring wear state of milling tools for complex thin-walled components, comprising:
a processor and a machining center mounted with tool cutting signal collection equipment; wherein
the tool cutting signal collection equipment of the machining center is configured to collect cutting signals in all cutting signal channels of a tool of the machining center, and transmit the collected cutting signals to the processor; and
the processor is configured to:
extract feature vectors of each of the cutting signal channels and constructing a signal feature matrix for the each of the cutting signal channels;
calculate a monotonicity of each of the feature vectors in the each of the cutting signal channels as a first index, calculate normalized mutual information of the each of the feature vectors in the each of the cutting signal channels and a tool wear vector as a second index, and calculate Spearman correlation coefficients between the each of the feature vectors in the each of the cutting signal channels and the tool wear vector, then calculate a third index based on a preset relationship between the Spearman correlation coefficients and the third index; wherein, the tool wear vector is constructed by the processor from historical tool wear amounts of the tool of the machining center measured by an electron microscope;
obtain feature behavior indexes corresponding to the each of the feature vectors in the each of the cutting signal channels according to a preset relationship between an accumulation sum of the first index, the second index and the third index and the feature behavior indexes;
calculate a cumulative average of the feature behavior indexes corresponding to the each of the feature vectors in the each of the cutting signal channels as a channel behavior index of a corresponding cutting signal channel;
sort the each of the cutting signal channels according to a size of the channel behavior index, screening the cutting signal channels with a set number of top rankings as input signal channels, and select a feature vector with a largest feature behavior index in time domain, frequency domain and time frequency domain of each of the input signal channels, respectively, to form model input vectors; and
output an online monitoring value of a wear amount of the tool of the machining center based on the model input vectors and the tool state recognition model trained in advance; wherein,
the tool of the machining center is replaced when the online monitored value of the wear amount of the tool is greater than a predefined wear amount threshold.

The beneficial effects of the present invention are as follows:
(1) According to the present invention, the channel of the input signals and the signal feature vectors of the tool state recognition model can be accurately determined by quantitatively characterizing the multi-domain feature behavior evolution law and the channel behavior evolution law of the cutting signals, and the problem that the tool wear monitoring accuracy is difficult to guarantee caused by the random influence of tool-workpiece vibration in the milling of thin-walled components is solved.
(2) According to the present invention, by calculating the Spearman correlation between the feature vector and the tool wear vector, the problem that the feature vector correlation relationship is difficult to characterize caused by the non-normal distribution of the cutting signal feature vector of the thin-walled component is solved; meanwhile, by directly setting the negative correlation feature vector behavior index to zero, the calculation amount is greatly reduced, and the calculation efficiency is effectively improved while ensuring the characterization accuracy.
(3) According to the present invention, the established tool state recognition model based on the lightweight GRU network comprises four-layer network structures, and the maximum number of each network units in each layer is only 64 and the minimum is 1; compared with the existing tool state monitoring model based on deep learning, the model structure is simple, the model parameters to be trained are few, and the model training can be completed by consuming very few computing resources, so that the state monitoring algorithm is easily adapted to the engineering practice of thin-walled workpiece machining.

### BRIEF DESCRIPTION OF DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 shows a flow chart according to one or more embodiments of the present invention;

FIG. 2 shows multi-signal channel multi-domain feature behavior indexes for each milling tool according to one or more embodiments of the present invention;

FIG. 3 shows multi-domain feature vector behavior characterization metrics according to one or more embodiments of the present invention;

FIG. 4 shows multi-signal channel behavior characterization metrics according to one or more embodiments of the present invention;

FIG. 5 shows a structure diagram of a tool state recognition model based on lightweight GRU network according to one or more embodiments of the present invention;

FIG. 6 shows a graph of a result of the tool wear monitoring compared with an actual wear amount of the tool for thin-walled workpiece milling according to one or more embodiments of the present invention.

### DETAILED DESCRIPTION OF THE INVENTION

### Embodiment 1

The present embodiment provide a method for monitoring wear state of milling tools for complex thin-walled components, comprising:
Step 1: collecting cutting signals in all cutting signal channels of a tool of a machining center by tool cutting signal collection equipment mounted on the machining center and transmitting to a processor;
Step 2: extracting, by the processor, feature vectors of each of the cutting signal channels and constructing a signal feature matrix for the each of the cutting signal channels;
Step 3: calculating, by the processor, a monotonicity of each of the feature vectors in the each of the cutting signal channels as a first index, calculating normalized mutual information of the each of the feature vectors in the each of the cutting signal channels and a tool wear vector as a second index, and calculating Spearman correlation coefficients between the each of the feature vectors in the each of the cutting signal channels and the tool wear vector, then calculating a third index based on a preset relationship between the Spearman correlation coefficients and the third index; wherein, the tool wear vector is constructed by the processor from historical tool wear amounts of the tool of the machining center measured by an electron microscope;
Step 4: obtaining, by the processor, feature behavior indexes corresponding to the each of the feature vectors in the each of the cutting signal channels according to a preset relationship between an accumulation sum of the first index, the second index and the third index and the feature behavior indexes;
Step 5: calculating, by the processor, a cumulative average of the feature behavior indexes corresponding to the each of the feature vectors in the each of the cutting signal channels as a channel behavior index of a corresponding cutting signal channel;
Step 6: sorting, by the processor, the each of the cutting signal channels according to a size of the channel behavior index, screening the cutting signal channels with a set number of top rankings as input signal channels, and selecting a feature vector with a largest feature behavior index in time domain, frequency domain and time frequency domain of each of the input signal channels, respectively, to form model input vectors;
Step 7: outputting, by the processor, an online monitoring value of a wear amount of the tool of the machining center based on the model input vectors and the tool state recognition model trained in advance; and
Step 8: replacing the tool of the machining center when the online monitored value of the wear amount of the tool is greater than a predefined wear amount threshold.

Specifically, in step 1, the cutting signal channels of the tool comprises a combination of at least any two signal channels of a milling force signal channel, a workpiece acceleration signal channel, a cutting noise signal channel, and an acoustic emission signal channel. For example, a rotary force measuring tool holder is used to collect the milling force signal in the milling force signal channel, and a three-axis accelerometer is used to collect the workpiece acceleration signal in the workpiece acceleration signal channel.

Steps 2 to 7 are performed in the processor.

It should be noted here that, when the wear amount of the tool of the machining center is monitored online in real-time, a calculation process of model input vectors is the same as a calculation process of the model input vectors for training the tool state recognition model.

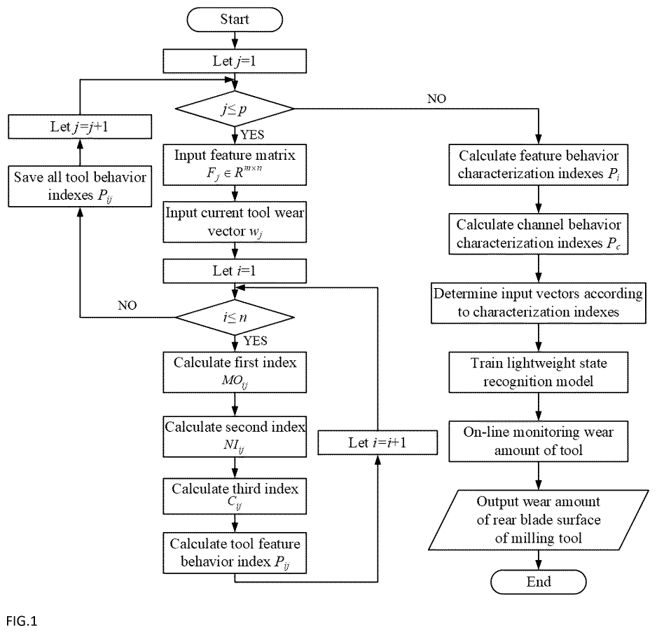

Specifically, referring to FIG. 1, the calculation process of the model input vector within the processor is as follows:
S1, inputting a signal feature matrix obtained from the cutting signal of the j^{th} tool of the machining center, which can be expressed as Fⱼ=(f₁ⱼ, f₂ⱼ, . . . , fᵢⱼ, . . . , fₙⱼ)∈R^{m×n}, where fᵢⱼ denotes the i^{th} feature vector in the feature space of the cutting signal of the j^{th} tool, m denotes the size of the cutting signal sample space, and n denotes the dimension of the feature space.
S2, for the each of the cutting signal channels of each tool of the machining center, the monotonicity of each of the feature vectors is cyclically calculated as the first index for evaluating feature behavior, wherein the monotonicity MOᵢⱼ of feature vector fᵢⱼ can be expressed by Equation (1), as follows:

$$M {O}_{i j} = \vert corr ( rank ( {f}_{i j} ) , rank ( {t}_{i j} ) ) \vert \qquad ( 1 )$$

where, corr denotes calculated Spearman rank correlation coefficient, rank denotes calculated Spearman rank, and ty denotes time series vector corresponding to feature vector fᵢⱼ.
S3, for the each of the cutting signal channels of the each tool of the machining center, the normalized mutual information NIᵢⱼ of the feature vector fᵢⱼ and tool wear vector wⱼ is cyclically calculated as the second index characterizing feature behavior, which can be expressed by Equation (2), as follows:

$${NI}_{i j} = \frac{{I}_{ij} ( {f}_{ij} ; {w}_{j} )}{H ( {f}_{ij} ) + H ( {w}_{j} )} \qquad ( 2 )$$

where, Iᵢⱼ(fᵢⱼ; wⱼ) denotes mutual information between computed feature vector fᵢⱼ and tool wear vector wⱼ of the j^{th} tool, and H(⋅) denotes computed vector information entropy.
S4, for the each of the cutting signal channels of the each tool of the machining center, the Spearman correlation coefficient between the feature vector fᵢⱼ and the tool wear vector wⱼ is cyclically calculated as the third index for evaluating the feature behavior; wherein, the performance index of the feature vector negatively correlated with the tool wear vector is directly set to zero by the ReLU function. The calculation process can be expressed by Equation (3), as follows:

$${C}_{i j} = R e L U ( {r}_{i j} ) ) \qquad ( 3 )$$

where, rᵢⱼ is the Spearman correlation coefficient between feature vector fᵢⱼ and tool wear vector wⱼ, which is:

$${r}_{i j} = 1 - \frac{6 {{\sum }_{u = 1}^{m} [ {d}_{ij}^{( u )} ]}^{2}}{m ( {m}^{2} - 1 )} \qquad ( 4 )$$

where,

$${d}_{ij}^{( u )}$$

denotes the rank difference between the u^{th} feature data in feature vector fᵢⱼ and the u^{th} tool wear value in tool wear vector wⱼ.

The distribution of signal feature vectors of thin-walled workpieces cut by the tools does not necessarily satisfy the normal distribution, and the traditional Pearson correlation coefficient is difficult to characterize the correlation between signal feature vectors and tool wear amount. In this step, Spearman correlation is calculated to solve the correlation characterization problem in monitoring of tool state in the thin-walled workpiece milling.

In addition, an expression of the ReLU function in equation (3) is:

$$R e L U ( x ) = max ( 0 , x ) \qquad ( 4 )$$

According to equations (3) and (5), the performance index of the feature vector negatively correlated with the tool wear vector can be directly set to zero through this step, unnecessary subsequent operations are reduced, and the efficiency of feature index calculation is greatly improved.
S5, based on the first index MOᵢⱼ, the second index NIᵢⱼ, and the third index Cᵢⱼ corresponding to the feature vector fᵢⱼ in the feature space of the j^{th} tool, the feature behavior index Pᵢⱼ corresponding to the tool feature vector fᵢⱼ can be obtained as:

$${P}_{ij} = σ ( {MO}_{ij} + {NI}_{ij} + {C}_{ij} ) \qquad ( 6 )$$

where, σ(⋅) denotes the Sigmoid activation function.

Based on this, the behavior index corresponding to each feature vector can be obtained by calculating the average value of the feature behavior index of all cutting tool feature vectors, which is expressed as:

$${P}_{i} = \frac{1}{p} {\sum }_{j = 1}^{p} {P}_{i j} \qquad ( 7 )$$

where, Pᵢ denotes the feature behavior index of the i^{th} feature vector, and p is the number of the tools used in the machining of the thin-walled workpieces; thus, quantitative characterization of the behavior of multi-domain eigenvectors in each signal channel is realized.
S6, for each cutting tool of machining center, calculating the accumulative average value of feature vector behavior indexes of the each of the signal channels, to characterize the behavior characterizations of signal channel, which is expressed as:

$${P}_{c} = \frac{1}{np} [ {\sum }_{i = 1}^{n} ( {\sum }_{j = 1}^{p} {P}_{ij} ) ] \qquad ( 8 )$$

where, P_{c} denotes the channel behavior characterization index of the c^{th} signal channel, so far, quantitative characterization of the behavior law of the multi-signal channel is realized.

After quantitative characterization of feature behavior rules and channel behavior rules is completed, lightweight monitoring and recognition of wear state of the tools for the thin-walled workpiece milling can be realized. The method for monitoring wear state of milling tools for complex thin-walled components comprises the following steps:
S7, comparing the channel behavior indexes P_{c} of the each of the signal channels, selecting the signal channels with the top two behavior indexes as input signal channels, and selecting a feature vector with the largest feature behavior index Pᵢⱼ in the time domain, frequency domain and time frequency domain of each of the input signal channels to form model input vectors, which is expressed as:

$$input = {[ {f}_{t}^{( 1 )} , {f}_{f}^{( 1 )} , {f}_{tf}^{( 1 )} , {f}_{t}^{( 2 )} , {f}_{f}^{( 2 )} , {f}_{tf}^{( 2 )} ]}^{T} where , {f}_{t}^{( 1 )} , {f}_{f}^{( 1 )} , and {f}_{tf}^{( 1 )} \qquad ( 9 )$$

respectively denote the feature vectors with the largest time domain, frequency domain, and time-frequency domain feature behavior indexes in the signal channel with the first behavior index ranking, and

$${f}_{t}^{( 2 )} , {f}_{f}^{( 2 )} , and {f}_{tf}^{( 2 )}$$

respectively denote the feature vectors with the largest time domain, frequency domain, and time-frequency domain feature behavior indexes in the signal channel with the second behavior index ranking.

In the process of training the tool state recognition model, the tool state recognition model is trained based on the input vectors obtained in S7, and the tool state recognition model adopts a lightweight GRU network with four layers in total, wherein the first layer contains 16 bidirectional GRUs, the second layer contains 32 bidirectional GRUs, the third layer is a fully connected layer containing 64 neurons, and the fourth layer is a fully connected layer containing 1 neuron.
where the expressions for the GRU are as follows:

$${z}_{i} = σ ( {W}_{z} {f}_{rf}^{( i )} + {U}_{z} \vec{{h}_{l - 1}} + {b}_{Z} ) \qquad ( 10 )$$

$${r}_{i} = σ ( {W}_{r} {f}_{rf}^{( i )} + {U}_{r} \vec{{h}_{l - 1}} + {b}_{r} ) \qquad ( 11 )$$

$$\tilde{{h}_{l}} = tan h ( {W}_{h} {f}_{rf}^{( i )} + {U}_{h} ( {r}_{i} ∘ \vec{{h}_{l - 1}} ) + {b}_{h} ) \qquad ( 12 )$$

$$\vec{{h}_{l}} = {z}_{i} ∘ \to \vec{{h}_{l - 1}} + ( 1 - {z}_{i} ) ∘ \tilde{{h}_{l}} \qquad ( 13 )$$

where, W*, U*, b*, and (*∈{h, r, z}) are weight matrices and bias vectors that can be learned, zᵢ is an update gate, rᵢ denotes a reset gate, \vec{hᵢ} and \vec{hᵢ₋₁} denote the current state and the state at the previous time, respectively; and, \tilde{h}ᵢ is candidate state.

An expression for the fully connected layers is:

$$output = R e L U ( WX + b ) \qquad ( 14 )$$

where, W and b are weight matrices and bias vectors that can be learned, and X is the output vector of the previous layer.

In the present embodiment, the model parameters in the training process are set as follows: the number of batches is 32, the learning rate is 0.001, and the number of training rounds is 300, and an RMSprop algorithm is used to optimize the training process.

The cutting signals are collected in real-time during the machining of thin-walled workpieces by the tools of the machining center, S1-S7 are repeated based on the collected cutting signals, and feature vectors are input into the trained tool state recognition model to realize lightweight on-line monitoring of the tool state.

The process signal can be a combination of any two signal channels of milling force, workpiece acceleration, cutting noise, and acoustic emission signals.

### Embodiment 2

In order to verify the feasibility of the first embodiment, a DMU70V five-axis machining center was used to carry out milling experiments of aerospace titanium alloy thin-walled parts and the milling tool wear measurement experiments.

The workpiece is Ti6Al4V rectangular thin plate, its geometric size is 150 mm*100 mm*5 mm; the milling tool is an insert two-edge end mill, and the tool diameter is 14 mm; the thin-walled workpiece is machined by a side milling, the spindle speed is 8000 r/min, the feed rate is 1280 mm/min, the radial cutting depth is 0.2 mm, and the axial cutting depth is 4 mm.

In order to verify the monitoring method, milling experiments with 100 passes of three identical tools were carried out in turn.

To improve the efficiency of the experiment, after every 10 passes, the wear amount of the tool flank is measured by an electron microscope. Based on the measured results, the wear amount of the tool flank corresponding to each pass is obtained by nonlinear interpolation, which is used as a data label. During the cutting process, vibration signals vₓ, v_{y}, and v_{z} of the machined workpiece in three directions of machine tool feed direction, vertical feed direction and axial direction are collected in real-time by a three-axis accelerometer, and milling forces fₓ, f_{y}, and f_{z} in three directions of tool tangential direction, radial direction and axial direction and milling torque m_{z} in axial direction are collected in real-time by a Kistler rotary force measuring tool holder.

For cutting signals of various channels during cutting of each tool, according to a table 2 in Document 1—“Fault diagnosis of rotating machinery based on multiple ANFIS combination with Gas[J], Mechanical Systems & Signal Processing, 2007, 21 (5): 2280-2294)”, sequentially extracting 11 time-domain features from p₁ to p₁₁ in the table, and extracting the maximum value of the signal as a supplement, totaling 12 time-domain features; and, 11 frequency-domain features expressed from p₁₂ to p₂₃ in the table. In addition, based on db1 wavelet basis function, performing 3-layer wavelet packet decomposition on cutting signals in each channel to obtain 8 wavelet packet energies, i.e., 8 time-frequency domain features, so that a total of 32 multi-domain features can be obtained, i.e., the signal feature matrix Fⱼ in step S1 is obtained, wherein the 1^{st} to 12^{th} feature vectors are time-domain features, the 13^{th} to 24^{th} feature vectors are frequency-domain features, and the 25^{th} to 32^{nd} feature vectors are time-frequency domain features. The size of signal sample space m is equal to the number of tool passes 100, and the dimension of feature space n is equal to the number of multi-domain features 32.

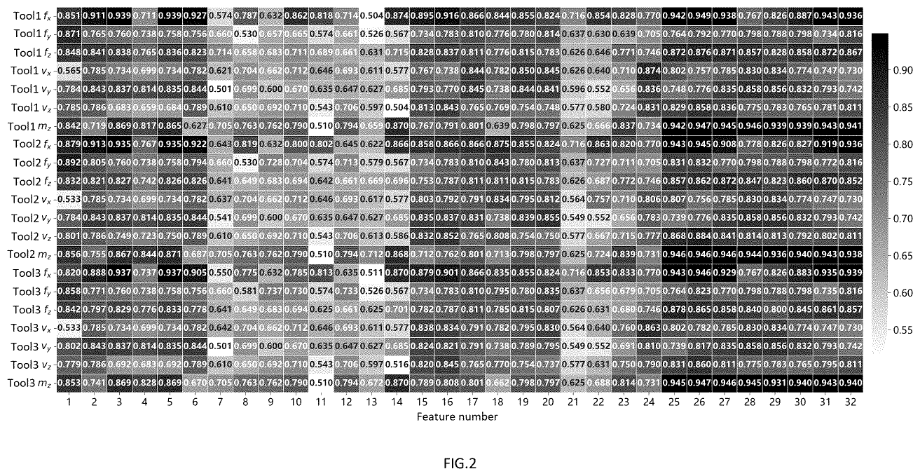

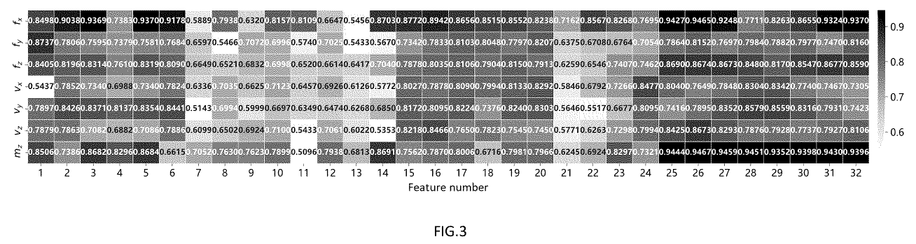

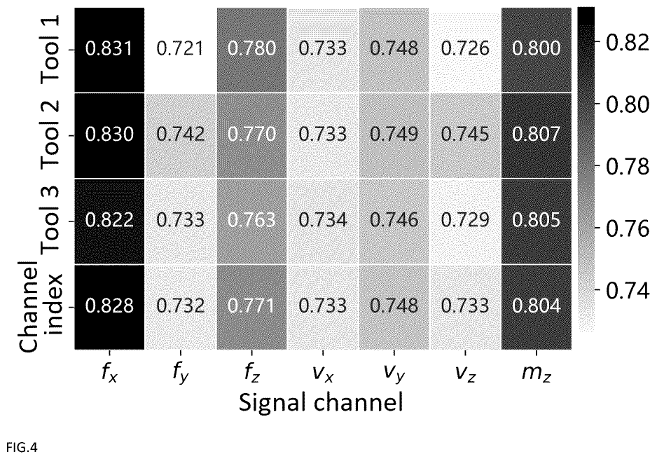

Therefore, for the cutting signals of each tool, the first index, the second index and the third index corresponding to each feature vector of each signal channel can be calculated according to steps S2 to S4, and the feature behavior index of each channel multi-domain feature vector of each tool can be obtained according to equation (6) in step S5, as shown in FIG. 2. Thus, the behavior characterization index corresponding to each feature vector can be obtained according to equation (7) in step S5, and its value is shown in FIG. 3. Based on this, quantitative characterization indexes of signal channel behavior can be obtained according to step S6, and FIG. 4 shows the calculated channel behavior indexes of each signal channel.

According to step S7, fₓ and m_{z} are selected as input signal channels based on FIG. 4, the 5^{th}, 16^{th}, and 26^{th} features are selected as input features of the fₓ channel based on FIG. 3, and the 5^{th}, 14^{th}, and 26^{th} features are selected as input features of the m_{z} channel based on FIG. 3, thereby obtaining the model input vector in step S7.

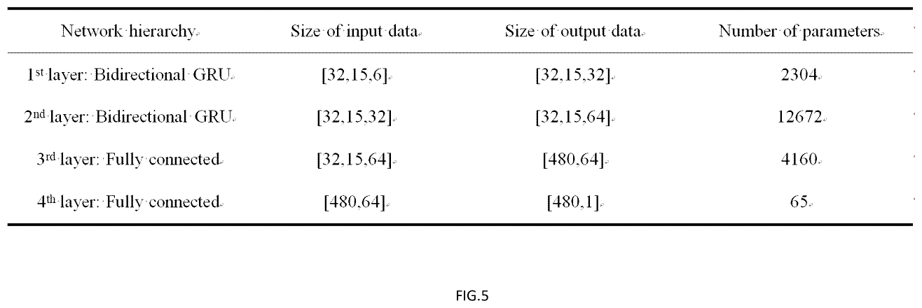

In the present embodiment, the cutting signals of tool #1 and tool #2 are used as training data, and the establishment and training of the tool state recognition model of the lightweight gated cyclic unit network can be completed. FIG. 5 shows the structure and parameter quantity of the trained model. Since 2 channels are input, and 3 feature vectors are input for each channel, according to step S8, the number of batches is set to 32. In this embodiment, the sequence length is set to 15, and the input data size is [32, 15, 6].

The first layer of the tool state recognition model is composed of 16 bidirectional GRUs, so the output data of the first layer is [32, 15, 32], and the size and parameter quantity of the input and output of the remaining layers can be obtained in turn according to step S8. Compared with the parameters of the tool state recognition model of milling tools for thin-walled components in a Document 2—“Wang R, Song Q, Peng Y, et al. A milling tool wear monitoring method with sensing generalization capability[J]. Journal of Manufacturing Systems, 2023, 68:25-41)” (see the Table 3 in the Document 2), the total number of parameters of the lightweight recognition model established in the present embodiment is reduced by more than 5.6 times, so the calculation efficiency is improved, and the calculation resource consumption is effectively reduced.

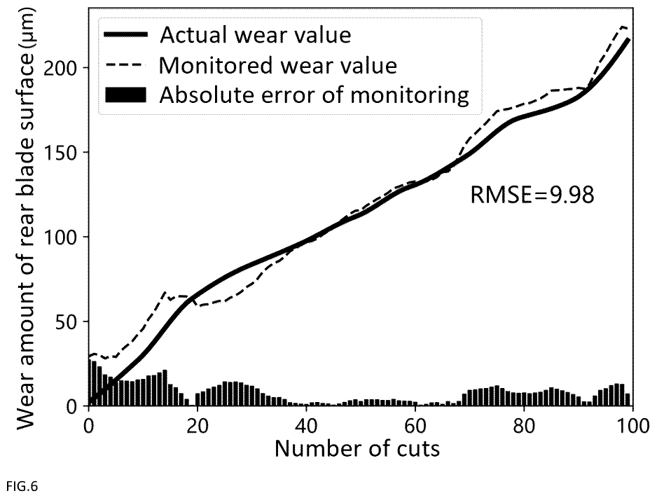

After the model training is completed, in the present embodiment, the cutting signals of the tool #3 is taken as test data, and lightweight online monitoring of the tool state can be realized based on the trained tool state recognition model. According to the monitoring results in FIG. 6, the root mean square error (RMSE) between the monitoring results and the real tool wear is calculated in turn as the accuracy evaluation index, and it is found that the RMSE between the monitoring results and the real results is 9.98. This is almost at the same level as the recognition accuracy of tool wear of milling tool for thin-walled components in the Document 2. However, since the present embodiment considers the multi-domain feature behavior law of milling signals of thin-walled components through quantitative characterization of feature evolution law, the present embodiment can realize accurate monitoring of wear state of milling tools only through lightweight tool state recognition model. The proposed method has high calculation efficiency in behavior law characterization process, low consumption of resources in model training process, and it is easier to popularize to the engineering practice of thin wall component machining.

### Embodiment 3

The present embodiment provides a system for monitoring wear state of milling tools for complex thin-walled components, comprising:
a processor and a machining center mounted with tool cutting signal collection equipment; wherein
the tool cutting signal collection equipment of the machining center is configured to collect cutting signals in all cutting signal channels of a tool of the machining center, and transmit the collected cutting signals to the processor; and
the processor is configured to:
extract feature vectors of each of the cutting signal channels and constructing a signal feature matrix for the each of the cutting signal channels;
calculate a monotonicity of each of the feature vectors in the each of the cutting signal channels as a first index, calculate normalized mutual information of the each of the feature vectors in the each of the cutting signal channels and a tool wear vector as a second index, and calculate Spearman correlation coefficients between the each of the feature vectors in the each of the cutting signal channels and the tool wear vector, then calculate a third index based on a preset relationship between the Spearman correlation coefficients and the third index; wherein, the tool wear vector is constructed by the processor from historical tool wear amounts of the tool of the machining center measured by an electron microscope;
obtain feature behavior indexes corresponding to the each of the feature vectors in the each of the cutting signal channels according to a preset relationship between an accumulation sum of the first index, the second index and the third index and the feature behavior indexes;
calculate a cumulative average of the feature behavior indexes corresponding to the each of the feature vectors in the each of the cutting signal channels as a channel behavior index of a corresponding cutting signal channel;
sort the each of the cutting signal channels according to a size of the channel behavior index, screening the cutting signal channels with a set number of top rankings as input signal channels, and select a feature vector with a largest feature behavior index in time domain, frequency domain and time frequency domain of each of the input signal channels, respectively, to form model input vectors; and
output an online monitoring value of a wear amount of the tool of the machining center based on the model input vectors and the tool state recognition model trained in advance; wherein,
the tool of the machining center is replaced when the online monitored value of the wear amount of the tool is greater than a predefined wear amount threshold.

### Embodiment 4

The present embodiment provides an electronic device, comprising a memory, a processor and a computer program stored in the memory and operable on the processor; wherein, when the processor executes the computer program, implementing the method for monitoring wear state of milling tools for complex thin-walled components according to Embodiment 1.

### Embodiment 5

The present embodiment provides a non-transitory computer readable storage medium storing a computer program thereon; wherein, when the computer program is executed by a processor, implementing the method for monitoring wear state of milling tools for complex thin-walled components according to the Embodiment 1.

The foregoing descriptions are merely preferred embodiments of the present invention but are not intended to limit the present invention. A person skilled in art may make various alterations and variations to the present invention. Any modification, equivalent replacement, or improvement made within the spirit and principle of the present invention shall fall within the protection scope of the present invention.

1. A method for monitoring wear state of milling tools for complex thin-walled components, comprising:
collecting cutting signals in all cutting signal channels of a tool of a machining center by tool cutting signal collection equipment mounted on the machining center and transmitting to a processor;
extracting, by the processor, feature vectors of each of the cutting signal channels and constructing a signal feature matrix for the each of the cutting signal channels;
calculating, by the processor, a monotonicity of each of the feature vectors in the each of the cutting signal channels as a first index, calculating normalized mutual information of the each of the feature vectors in the each of the cutting signal channels and a tool wear vector as a second index, and calculating Spearman correlation coefficients between the each of the feature vectors in the each of the cutting signal channels and the tool wear vector, then calculating a third index based on a preset relationship between the Spearman correlation coefficients and the third index; wherein, the tool wear vector is constructed by the processor from historical tool wear amounts of the tool of the machining center measured by an electron microscope;
obtaining, by the processor, feature behavior indexes corresponding to the each of the feature vectors in the each of the cutting signal channels according to a preset relationship between an accumulation sum of the first index, the second index and the third index and the feature behavior indexes;
calculating, by the processor, a cumulative average of the feature behavior indexes corresponding to the each of the feature vectors in the each of the cutting signal channels as a channel behavior index of a corresponding cutting signal channel;
sorting, by the processor, the each of the cutting signal channels according to a size of the channel behavior index, screening the cutting signal channels with a set number of top rankings as input signal channels, and selecting a feature vector with a largest feature behavior index in time domain, frequency domain and time frequency domain of each of the input signal channels, respectively, to form model input vectors;
outputting, by the processor, an online monitoring value of a wear amount of the tool of the machining center based on the model input vectors and the tool state recognition model trained in advance; and
replacing the tool of the machining center when the online monitored value of the wear amount of the tool is greater than a predefined wear amount threshold.

2. The method according to claim 1, wherein the processor calculates the monotonicity of the each of the feature vectors in the each of the cutting signal channels, comprising:
$$M {O}_{i j} = \vert corr ( rank ( {f}_{ij} ) , rank ( {t}_{ij} ) ) \vert$$
where, MOᵢⱼ denotes monotonicity of feature vector; corr denotes calculated Spearman rank correlation coefficient, rank denotes calculated Spearman rank, and ty denotes time series vector corresponding to feature vector fᵢⱼ.

3. The method according to claim 1, wherein the processor calculates the normalized mutual information of the each of the feature vectors in the each of the cutting signal channels and the tool wear vector, comprising:
$${NI}_{ij} = \frac{{I}_{ij} ( {f}_{ij} ; {w}_{j} )}{H ( {f}_{ij} ) + H ( {w}_{j} )}$$
where, NIᵢⱼ denotes normalized mutual information between feature vector fᵢⱼ and tool wear vector wⱼ; Iᵢⱼ(fᵢⱼ; wⱼ) denotes mutual information between computed feature vector fᵢⱼ and tool wear vector wⱼ of the j^{th} tool; H(⋅) denotes computed vector information entropy.

4. The method according to claim 1, wherein the processor calculates the third index, comprising:
$${C}_{ij} = ReLU ( {r}_{ij} ) ,$$
$${r}_{ij} = 1 - \frac{6 {{\sum }_{u = 1}^{m} [ {d}_{ij}^{( u )} ]}^{2}}{m ( {m}^{2} - 1 )} , and$$
$$ReLU ( x ) = max ( 0 , x ) ,$$
where, rᵢⱼ is the Spearman correlation coefficient between feature vector fᵢⱼ and tool wear vector wⱼ; ReLU(x) is the expression of ReLU function;
$${d}_{ij}^{( u )}$$
denotes the rank difference between the u^{th} feature data in feature vector fᵢⱼ and the u^{th} tool wear value in tool wear vector wⱼ.

5. The method according to claim 1, wherein the preset relationship between the accumulation sum of the first index, the second index and the third index and the feature behavior index, comprising:
$${P}_{ij} = σ ( M {O}_{ij} + {NI}_{ij} + {C}_{ij} )$$
where, Pᵢⱼ denotes the feature behavior index corresponding to the feature vector fᵢⱼ; MOᵢⱼ, NIᵢⱼ, and Cᵢⱼ denote the first index, the second index, and the third index corresponding to the feature vector fᵢⱼ, respectively; σ(⋅) denotes the Sigmoid activation function.

6. The method according to claim 1, wherein the cutting signal channels of the tool comprises a combination of at least any two signal channels of a milling force signal channel, a workpiece acceleration signal channel, a cutting noise signal channel and an acoustic emission signal channel.

7. The method according to claim 6, wherein milling force signals in the milling force signal channel are collected by a rotary force measuring tool holder.

8. The method according to claim 6, wherein workpiece acceleration signals in the workpiece acceleration signal channel are collected by a three-axis accelerometer.

9. The method according to claim 1, wherein the tool state recognition model is a lightweight gate recurrent unit (GRU) network with four layers, wherein a first layer and a second layer comprise a plurality of bidirectional GRUs, and a third layer and a fourth layer comprise a plurality of fully connected layers of neurons.

10. A system for monitoring wear state of milling tools for complex thin-walled components, comprising:
a processor and a machining center mounted with tool cutting signal collection equipment; wherein
the tool cutting signal collection equipment of the machining center is configured to collect cutting signals in all cutting signal channels of a tool of the machining center, and transmit the collected cutting signals to the processor; and
the processor is configured to:
extract feature vectors of each of the cutting signal channels and constructing a signal feature matrix for the each of the cutting signal channels;
calculate a monotonicity of each of the feature vectors in the each of the cutting signal channels as a first index, calculate normalized mutual information of the each of the feature vectors in the each of the cutting signal channels and a tool wear vector as a second index, and calculate Spearman correlation coefficients between the each of the feature vectors in the each of the cutting signal channels and the tool wear vector, then calculate a third index based on a preset relationship between the Spearman correlation coefficients and the third index; wherein, the tool wear vector is constructed by the processor from historical tool wear amounts of the tool of the machining center measured by an electron microscope;
obtain feature behavior indexes corresponding to the each of the feature vectors in the each of the cutting signal channels according to a preset relationship between an accumulation sum of the first index, the second index and the third index and the feature behavior indexes;
calculate a cumulative average of the feature behavior indexes corresponding to the each of the feature vectors in the each of the cutting signal channels as a channel behavior index of a corresponding cutting signal channel;
sort the each of the cutting signal channels according to a size of the channel behavior index, screening the cutting signal channels with a set number of top rankings as input signal channels, and select a feature vector with a largest feature behavior index in time domain, frequency domain and time frequency domain of each of the input signal channels, respectively, to form model input vectors; and
output an online monitoring value of a wear amount of the tool of the machining center based on the model input vectors and the tool state recognition model trained in advance; wherein, replacing the tool of the machining center when the online monitored value of the wear amount of the tool is greater than a predefined wear amount threshold.
